(19) United States
(12) Patent Application Publication
(10) Pub. No.: US 2003/0132423 A1
(43) Pub. Date: Jul. 17, 2003

(54) Supersolv a fast super-glue remover solvent

(76) Inventor: Margaret Williams Garvia, Davie, FL (US)

Correspondence Address: MARGARET W. GARVIA, 951 Seabrook Ave., Davie, FL, 33325, US

(21) Appl. No.: 10/043,293

(22) Filed: Jan. 14, 2002

(51) Int. Cl. B01F 1/00

(52) U.S. Cl. 252/364

(57) ABSTRACT

The glue remover contains a combination of five solvents which rapidly loosen, dissolve and remove both dried and wet cyanoacrylate glues from most surfaces. This solvent mixture is safe for short-time use on human skin. The combination gives a synergistic effect which allows faster softening and removal of the dried glue. The solvent mixture contains special solvents which are combined in optimum ratios to give a significant increase in solvent power greater than possible with any one solvent while also providing two solvents, isoamyl acetate and propylene glycol, to soothe the skin in addition to helping loosen the dried glue.

### BACKGROUND OF THE INVENTION

1. Field of the Invention

This invention relates to a combination of relatively safe but powerful solvents intended to remove cured and uncured cyanoacrylate glues from human skin and most other surfaces

2. Description of the Related Art

No instant or “superglue” solvent has been patented. When instant glue or superglue products are accidentally spilled on human skin or other surfaces, the glue is removed very slowly with great difficulty. In such cases, it is very difficult, painful, and time-consuming to separate fingers or to extracate a finger, hand, arm, etc., from another contact surface. Some common solvents, such as nail polish remover, isopropyl alcohol, or acetone are often used but these solvents do not work well or rapidly. This solvent quickly loosens the dried glue and allows easy removal with a cloth or paper to wipe off the material.

### SUMMARY OF THE INVENTION

The present invention is directed to a combination of relatively safe solvents which show synergistic ability to loosen and dissolve dry cured cyanoacrylate glue quickly from human skin and other surfaces. Each of the five solvents when used alone has some value to loosen such glue (dried and wet) but the proprietary combination quickly and more effectively loosens the glue (dried and wet) and allows scraping off with paper, cloth, or other material. In a preferred embodiment, nitromethane, isoamyl acetate, ethyl alcohol, acetone, and propylene glycol (approximately at the levels of 65%, 25%, 5%, 3%, and 2%, respectively are used. While the described invention can be considered a preferred and practical embodiment, it is recognized that departures may be made within reasonable limits to achieve good results also within the scope of the invention which is not to be limited except as set forth in the following claims and within the doctrine of equivalents. The claims are given in the next section.

### CROSS-REFERENCES TO RELATED APPLICATIONS

No patent references related to the present glue solvent were found in a 20 year search of the U.S. Patent and Trademark Office patents.

1. This product consists of synergistic solvent components found to be effective for removing all cyanoacrylate type glues, including instant cured “Superglue”, as well as slow curing varieties and fresh liquid cyanoacrylate glues.

2. This solvent safely removes both cured and uncured cyanacrylate glues attached to human skin and most other surfaces.

3. This solvent mixture consists of relatively safe but powerful solvents consisting of the following:
(1) One or more nitroalkanes (primary and secondary) with total chain lengths of C-1 to C-8 (for example nitroethane)
(2) One or more alkyl alcohols (primary, secondary, and tertiary) with total chain lengths of C-1 to C-8 (for example isopropanol)
(3) One or more alkyl ketones (all are secondary) with individual chain lengths of C-1 to C-6 (for example acetone or dimethyl ketone)
(4) One or more alkyl esters (primary and secondary) with individual alkyl chain lengths of C-1 to C-6 (for example isoamyl acetate).
(5) One or more alkane glycols (primary, secondary) with individual alkyl chain lengths of C-2 to C-6 (for example propylene glycol).

4. This solvent mixture removes cured and uncured cyanoacrylate glue from all surfaces, including skin, much faster, more effectively, and more completely than acetone and other solvents commonly used.
